(19) United States
(12) Patent Application Publication
(10) Pub. No.: US 2017/0142132 A1
(43) Pub. Date: May 18, 2017

(54) Monitoring Network Traffic

(71) Applicant: HEWLETT PACKARD ENTERPRISE DEVELOPMENT LP, Houston, TX (US)

(72) Inventors: Joseph A. CURCIO, Roseville, CA (US); Jechun CHIU, Austin, TX (US); Bruce E. LAVIGNE, Roseville, CA (US); Wei LU, Austin, TX (US); Shaun WAKUMOTO, Roseville, CA (US); Mauricio SANCHEZ, San Francisco, CA (US); Matthew LASWELL, Austin, TX (US)

(21) Appl. No.: 15/316,741

(22) PCT Filed: Jun. 10, 2014
(86) PCT No.: PCT/US2014/041750

§ 371 Date: Dec. 6, 2016

(51) Int. Cl. H04L 29/06

(52) U.S. Cl. CPC H04L 63/1408; H04L 69/22; H04L 63/0227

(57) ABSTRACT

An example of a computing system is described herein. The computing system includes a network switch configured to direct network traffic. The computing system also includes a network device to receive the network traffic. The computing system further includes a controller coupled to the network switch. The controller is to monitor network traffic in the network switch and generate a policy to instruct the network switch in selecting a portion of the network traffic to direct to the network device.

### BACKGROUND

A network can include a variety of devices that transfer data throughout the network. This data is typically contained within packets that are transferred by switches, routers, or other network devices. In some cases, it may be desirable to monitor network traffic. For example, some data packets may include viruses or other malicious code. Monitoring network traffic may enable an administrator or other user to extract useful data, such as whether the network is under attack by malicious code.

### BRIEF DESCRIPTION OF THE DRAWINGS

Certain examples are described in the following detailed description and in reference to the drawings, in which:

FIG. 1 is a block diagram of an example of a network;

FIG. 2 is a block diagram of an example of a controller;

FIG. 3 is a process network traffic diagram of an example of a method of monitoring network traffic;

FIG. 4 is a process network traffic diagram of an example of another method of monitoring network traffic; and

FIG. 5 is a block diagram of an example of a tangible, non-transitory, computer-readable medium that stores code configured to monitor network traffic.

### DETAILED DESCRIPTION OF SPECIFIC EMBODIMENTS

The present disclosure provides techniques for monitoring network traffic. Network switches can transfer data through a network in the form of packets. Each network switch can transfer data to a variety of network devices. However, as the network switches operate independently in terms of coordinating their traffic loads to another network device, the network switches cannot track the data transferred beyond each individual switch and the network can be vulnerable to a variety of problems. For example, because the switches cannot monitor packets transferred by other switches, the packets that are transferred by multiple network switches can overload the device. In another example, the network switches can transfer packets to a malfunctioning device. In a further example, the network switches can be unable to track security risks in the network traffic.

The trend in network malicious code and intrusion payload transmission is rising with network proliferation. This rise in malicious code and intrusion payload transmission has spawned an industry that produces security products that provide packet inspection, sometimes known as “deep packet inspection” (DPI). Examples of packet inspection can include intrusion detection systems (IDS), intrusion prevention systems (IPS), and next generation firewalls, among others. Traditional packet inspection deployments can be fixed “bump-in-the-wire” dedicated middle boxes. Bump-in-the-wire refers to a network security device that is inserted at a specific point in the network between two dedicated device ports, and can only inspect traffic flowing between these two dedicated device ports. Accordingly, these bump-in-the-wire deployments provide network defense that is limited in scale by fixed “port segments”. Port segments are pairs of network connections to connect a device to a network. Physical segments are often oversized and underutilized. In order to overcome these limitations, multiple packet inspection devices can be purchased and distributed across the network to provide predetermined protection of specific physical links and topologies. However, the network is rendered unprotected while the packet inspection devices are redeployed to different segments of the network. In addition, the per-port cost for these packet inspection devices is typically high. This high cost has been prohibitive in distributing multiple high-performance packet inspection devices below distribution switches in a network.

However, by employing a controller to monitor and control network traffic, the workload of network traffic can be distributed across the network. Further, by employing the controller to monitor and control network traffic to a network security device in the network, the network security device can act as a programmable service for multiple switches in the network. Network security devices are devices that scan packets to detect malicious activity and/or content in the network traffic. For example, network security devices can be packet inspection devices, such as deep packet inspection (DPI) technologies. In addition, by carefully monitoring and controlling network traffic from the network switches to the network security device, the workload of the network security device can be customized to the network security device's capabilities and use of the network security device bandwidth can be optimized. Further, as only a single network security device may be employed to service multiple switches, costs of the network are decreased as compared to a network including a plurality of network security devices.

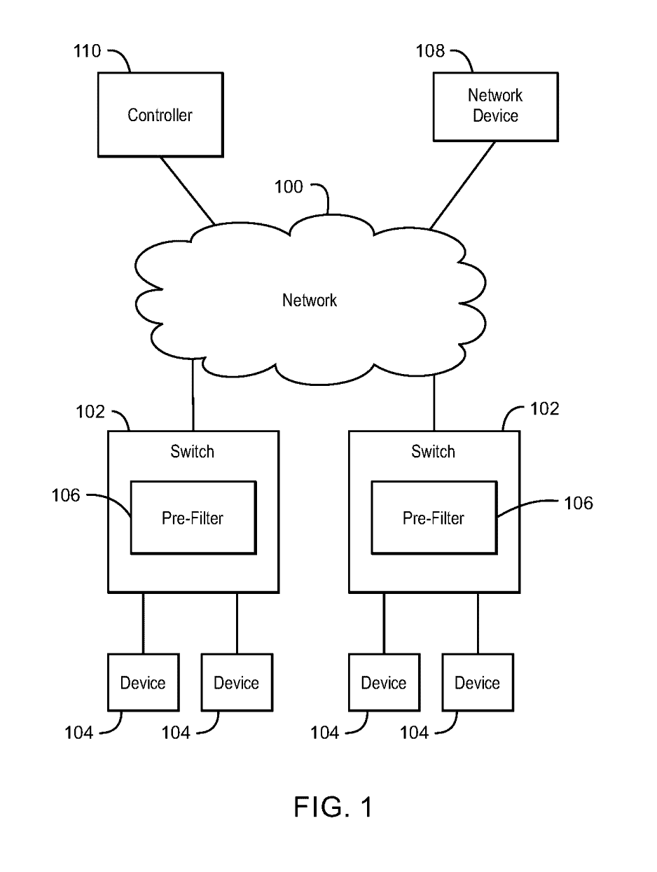

FIG. 1 is a block diagram of an example of a computing system. In an example, the computing system can be a network 100. The network 100 includes a switch 102. In an example, the network can include a plurality of switches 102. The switches 102 receive incoming network traffic (data) and perform packet switching to process and forward the network traffic in the form of packets. The packets are directed to devices coupled to the network 100. Each switch 102 can include a plurality of devices 104 coupled to the switch. The switch 102 can transfer network traffic to and from these devices 104. The devices 104 can include any suitable type of computing device, such as a memory device, a computer, a client device, a printing device, a wireless Access Point (AP), or any other suitable type of device. Each switch can further include a pre-filter 106. The pre-filter 106 can scan the network traffic to identify targeted types of packet data. For example, the pre-filter 106 can scan the network traffic to determine if malicious activity or content is potentially present in the network traffic. In another example, the pre-filter 106 can scan the network traffic to determine if malicious code is present in the network traffic. Network traffic found to include targeted types of packet data can be identified and addressed. Suspicious network traffic can be directed to other network devices for deeper scanning. For example, network traffic found to potentially include malicious code can be diverted to a network security device for additional scanning.

The network 100 can also include a network device 108. In an example, the network 100 can include a plurality of network devices 108. The network device 108 can be any type of device, such as a memory storage device or a network security device to perform packet inspection. Network security devices are devices that scan packets to detect malicious activity and/or content in the network traffic. For example, network security devices can include deep packet inspection (DPI) technologies. In an example, network security devices 108 can be discrete devices in the network 100. In another example, a network security device 108 can be included in a switch 102 of the network 100. Network traffic, such as a predetermined portion of the network traffic can be directed from the switches 102 to the network device 108. The portion of the network traffic can be selected in a variety of ways, which will be addressed below.

The network 100 further includes a controller 110. In an example, the controller 110 is a discrete device. In another example, the controller 110 is included in the switch 102. The controller 110 monitors and controls traffic in the network. The controller 110 monitors the capabilities of the devices of the network 100 and the network traffic and, based on this information, determines the destination of network traffic. The controller 110 creates a policy(s) including instructions directing the network switch 102 to direct the network traffic to the determined destination. For example, when the network device 108 is a network security device, the controller 110 monitors the capabilities of and traffic sent to the network security device. Based on this information, the controller 110 can create a policy instructing the network switch which portion of network traffic to divert to the network device 108 for scanning. This policy is transmitted from the controller 110 to the switches 102 and the switches 102 divert the selected portion of the network traffic to the network security device based on the policy.

The portion of network traffic to divert to the network security device for scanning can be determined in a number of ways. For example, in the event that a new network connection is established with a new device, the new device or the switch 102 to which the new device connects can notify the controller of the new network connection. The controller can create a policy including instructions directing the switch 102 to divert network traffic from the new network connection to the network security device for a calculated period of time. This period of time can be set by the policy or calculated by an algorithm. In addition, this period of time can differ between network connections. For example, network traffic from the new network connection can be scanned for a longer period of time than network traffic from an authenticated network connection. In another example, network traffic from a new user or a guest user can be scanned for a longer period of time than network traffic from an authenticated user. The new device can be any suitable device, such as a client, a mobile, device, or a personal computer (PC), among others. The new device may be connected to the network via a switch 102.

In another example, the policy can include instructions directing the switch 102 to divert a calculated amount of network traffic from the new network connection to the network security device. This amount of network traffic can be set by the policy or calculated by an algorithm. In addition, this amount of network traffic to be scanned can differ between network connections. For example, a larger amount of network traffic from the new network connection can be scanned than the amount of network traffic from an authenticated network connection. In another example, a larger amount of network traffic from a new user or a guest user can be scanned than the amount of network traffic from an authenticated user. The controller can direct the network security device to scan the new network connection until the network connection is determined to be clean or free of malicious activity/content. Network traffic from the new connection can be prioritized in the network security device over network traffic from a previously established connection(s). When the network traffic from the new network connection is determined to be free of security threats, the network scanning can return to scanning network traffic from the previously established connection(s).

In a further example, the policy can include instructions directing the switch 102 to select a calculated amount of network traffic to divert to the network security device. The instructions can direct the switch 102 to randomly select the calculated mount of network traffic. For example, the policy can direct the switch 102 to make the selection at preselected time intervals or when a certain amount of time has passed (timeslicing). In another example, a combination of these methods, or any other suitable method, can be employed in order to increase the chances of detecting a security risk in the network traffic.

The controller 110 can dynamically reconfigure the policy based upon the state of the network. For example, upon being notified of a new network connection, the controller 110 can reconfigure the policy to instruct the switch 102 to prioritize processing of network traffic from the new network connection. When the network traffic from the new network connection has been processed, the controller 110 can reconfigure the policy to instruct the switch 102 to return to processing network traffic from previously established network connections. In addition, the controller 110 can scale availability of the network devices 108 by scaling and rotating network traffic into the network devices 108 to process the entire network 100 over time. Further, the controller 110 can reconfigure the policy to maximize the resources of the network devices 108. For example, when the controller 110 determines that a particular policy has overloaded a network device 108, the controller 110 can change the policy to reduce the workload of the network device 108.

In an example, the switch 102 can pre-filter the network traffic to select the portion of network traffic to be diverted to a network security device for scanning. Suspicious network traffic can be directed to the network security device for more intensive scanning. Further, because the controller 110 monitors the capabilities and workload of the components of the network 100, including the network security device, the controller 110 can reconfigure the policy in order to optimize the capabilities (e.g., the bandwidth) of the network security device and to prevent the network security device from being overloaded.

The network security device scans the selected portion of the network traffic and notifies the controller 110 and/or the switch 102 from which the infected network traffic originated. The controller 110 determines what action to take to address the infected network traffic and instructs the switch 102 to carry out the determined action. In an example, the policy can include a series of instructions for given situations. When the switch 102 encounters a situation listed in the policy, the switch 102 follows the instructions for addressing the given situation as provided by the policy.

It is to be understood the block diagram of FIG. 1 is not intended to indicate that the computing system 100 is to include all of the components shown in FIG. 1 in every case. Further, any number of additional components can be included within the computing system 100, depending on the details of the specific implementation.

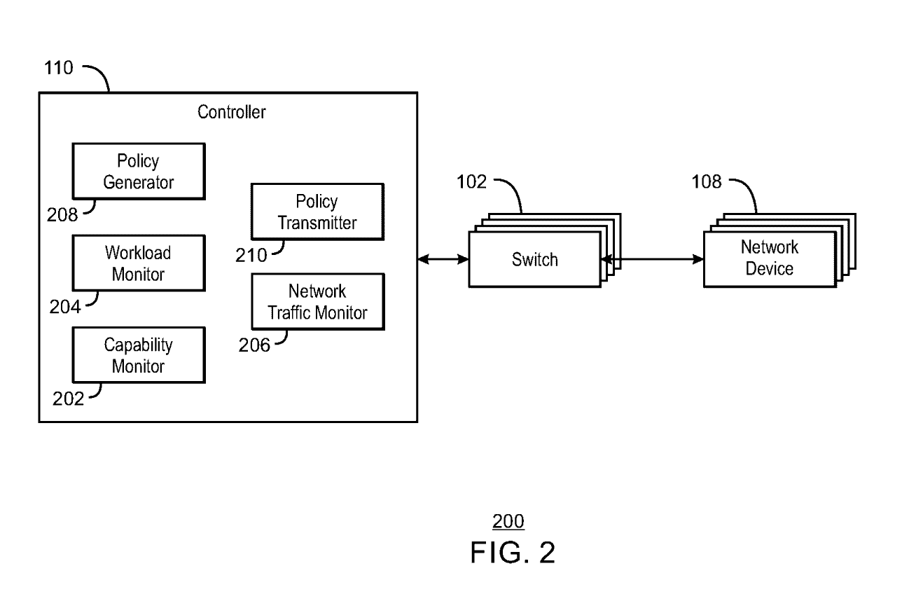

FIG. 2 is a block diagram of an example of a controller 110. The controller 110 includes a capability monitor 202. The capability monitor 202 monitors the capabilities of each network device. For example, the capability monitor 202 monitors the capabilities of each network switch 102 and the network device 108. These capabilities include bandwidth, throughput, latency, supported protocols, supported functionalities, supported DPI technologies, and supported policies, flow entries, and sets of signatures, among others. The capabilities of each network device are registered with the controller 110 upon addition of the network devices to the network 100 and the controller 110 continues to monitor the network devices to determine any changes in the registered capabilities.

The controller 110 also includes a workload monitor 204. The workload monitor 204 continually monitors the workload of each network device 108. For example, the workload monitor 204 monitors the workload of the network device 108. The workload of each network device 108 can be determined by the amount of network traffic that is currently directed to the network device 108 and the amount of resources to be used in processing the network traffic directed to the network device 108. For example, the workload of a network security device can be determined by the amount of network traffic directed to the network security device and the amount of processing cycles to be used in scanning the network traffic directed to the network security device.

The controller 110 further includes a network traffic monitor 206. The network traffic monitor 206 monitors the network traffic flowing through each switch 102 of the network. In addition, the network traffic monitor 206 classifies the network traffic, determining the size of the network traffic, the complexity of the network traffic, the bandwidth of the network traffic, the amount of network traffic for a particular period of time, the type of network traffic, and the resources to be used in processing each packet, among others. By classifying the network traffic, the controller 110 is able to determine the amount of resources to be used in processing the network traffic.

The controller 110 additionally includes a policy generator 208. The policy generator 208 creates a policy that includes instructions to a network switch 102 in directing network traffic. The policy includes instructions on selecting a portion of network traffic to direct to a network device 108. For example, the policy can include instructions on selecting a portion of network traffic to direct to a network security device.

In an example, for network traffic not selected for scanning by a network security device, the network switch 102 can direct the network traffic according to a standard policy, directing the network traffic to the original destination. However, for network traffic selected for scanning by a network security device, the policy includes instructions directing the network switch 102 in directing the network traffic to the network security device.

In addition, when the network security device detects a security risk upon scanning the network traffic, the network security device can notify the controller 110. The policy generator 208 can update the policy or create a new policy to address the identified security risk. The security risk can be addressed in any suitable manner including blocking, re-directing, mirroring, metering, counting, quarantining, and/or like type of alternative processing of the network traffic including the security risk, or any combination thereof. Because the controller 110 monitors the network traffic and the workload, the controller may be able to identify the client or device from which the network traffic originates. Further, the controller 110 can also determine the exact nature of the infected network traffic and the timing and history of the infection of the network traffic. In an example, the controller 110 can direct the switch 102 to quarantine the client/device from which the infection occurred from the rest of the network until the infection is addressed. Further, the controller 110 can direct the switch 102 to more closely monitor clients/devices which were communicating with the infected client/device to determine if the client/device is also infected. For example, the controller 112 can quarantine the client/device to which the infection may have been transmitted. The degree of response to an infection can depend on the level of risk of the infection. For example, a low-level risk violation may result in metering, while a high-level risk may result in immediate blocking. In another example, a device or traffic flow that includes frequent violations can be quarantined until the identified security threat is addressed. Additionally, the controller 110 can issue exact alerts about the infected network traffic.

Further, because the workload monitor 204 monitors the workload of the network device 108, the workload monitor 204 can recognize when the network device 108 is overloaded and/or when the efficiency of the network device 108 decreases. In this case, the policy generator 208 can modify the policy to change the network traffic directed to the network device 108 or generate a new policy. This change can take any suitable form. For example, the policy can change how much network traffic is selected to be directed to the network device 108.

The controller 110 further includes a policy transmitter 210. The policy transmitter 210 transmits the policy created by the policy generator 208 to a network switch 102. Upon receiving the policy, the network switch 102 acts upon the instructions included in the policy.

It is to be understood the block diagram of FIG. 2 is not intended to indicate that the controller 110 is to include all of the components shown in FIG. 2 in every case. Further, any number of additional components can be included within the controller 110, depending on the details of the specific implementation.

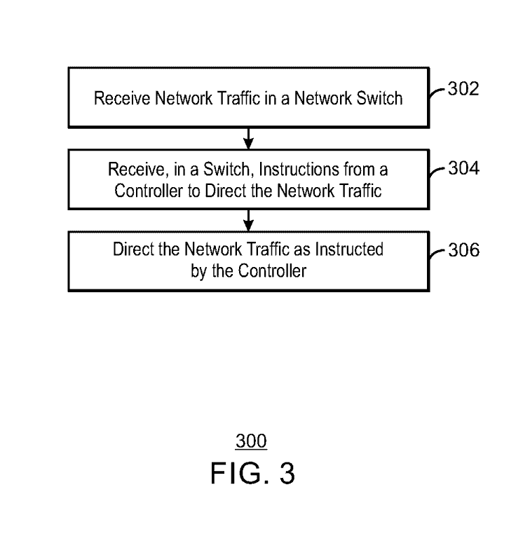

FIG. 3 is a process network traffic diagram of an example of a method 300 of directing network traffic. For example, the method 300 can be executed by the network switch described with respect to FIG. 2.

At block 302, network traffic can be received in a network switch. The network traffic can be received in the form of packets. These packets can be processed in preparation for being directed by the network switch. The packets can be addressed to a device coupled to the network switch, or the packets can be received from a device coupled to the network switch.

At block 304, instructions to direct the network traffic can be received in the switch from a controller such as a software-defined network (SDN) controller. The instructions are received in the form of a policy. The policy is created by the controller based on the capabilities and network traffic as determined by the controller. The controller monitors the devices of the network in order to create policies for directing network traffic.

At block 306, the network traffic is directed by the network switch as instructed by the controller. The controller can create any suitable policy, such as the policies described above in relation to FIG. 1, to instruct the network switch in directing the network traffic.

It is to be understood that the process network traffic diagram of FIG. 3 is not intended to indicate that the elements of the method 300 are to be executed in any particular order, or that all of the elements of the method 300 are to be included in every case. Further, any number of additional elements not shown in FIG. 3 can be included within the method 300, depending on the details of the specific implementation.

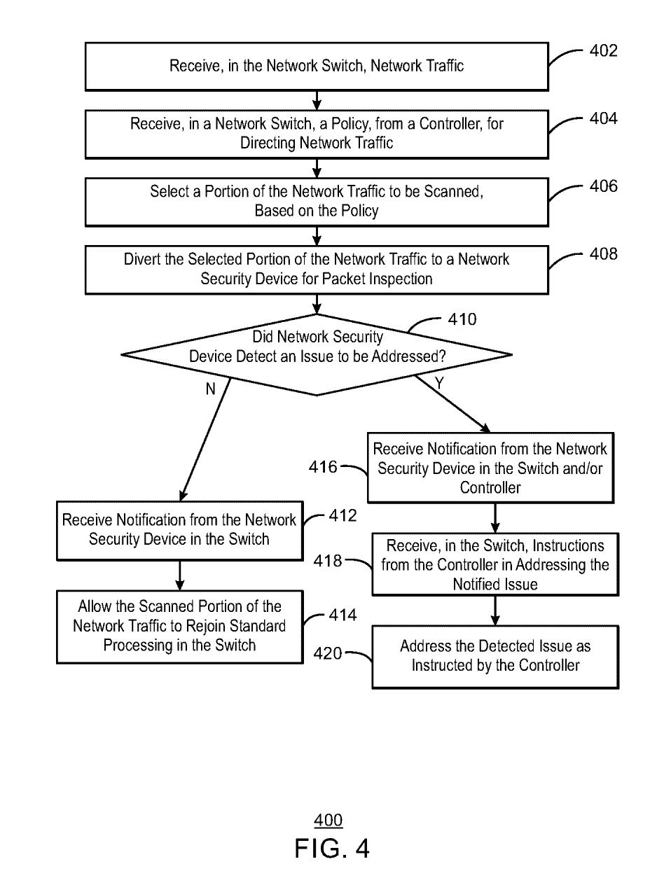

FIG. 4 is a process network traffic diagram of an example of another method of directing network traffic. For example, the method 400 can be executed by the network device described with respect to FIG. 2.

At block 402, network traffic (data) can be received in a network switch. The network traffic can be received in the form of packets. These packets can be processed in preparation for being directed by the network switch. The packets can be addressed to a device coupled to the network switch, or the packets can be received from a device coupled to the network switch.

At block 404, a policy for directing network traffic is received from a controller in a network switch. The policy is created by the controller based on the capabilities and traffic network traffic as determined by the controller. The controller monitors the devices of the network in order to create policies for directing network traffic. The policy is a set of instructions to direct the network traffic as determined by the controller. The controller can create the policy such that the capabilities (e.g., the bandwidth) of the network security device are optimized.

At block 406, a portion of the network traffic is selected to be scanned, based on the policy. The portion of the network traffic can be selected by any suitable means. For example, the portion of the network traffic can be selected as described with respect to FIG. 1.

At block 408, the selected portion of the network traffic is diverted to the network security device for packet inspection. The network security device inspects the network device for the presence of a security threat or any other similar types of defects which can harm the network and/or attached devices. At block 410, the network security device determines whether an issue is to be addressed, such as a security threat.

If there is no issue to be addressed, at block 412, notification of this lack of issues is received in the switch. At block 414, the scanned portion of the network traffic is allowed to rejoin standard processing in the switch. If an issue to be addressed is identified, notification of this issue is received in the switch and/or in the controller at block 416. For example, the network security device may notify the switch, which then passes the notification to the controller, or the network security device may notify the controller directly. At block 418, instructions for addressing the notified issue are received from the controller in the switch. Because the controller monitors and interacts with all of the switches in the network, the controller is able to determine where the infected network traffic originated (e.g., from which device or client), what the issue or threat specifically entails, and when (e.g., the time and history) the infection occurred. Further, the controller can issue detailed alerts on the infected network traffic in order to protect the rest of the network from infection. These instructions can include any suitable method of addressing the issue. For example, the controller can instruct the switch to quarantine the infected network traffic. At block 420, the switch addresses the detected issue as instructed by the controller.

It is to be understood that the process network traffic diagram of FIG. 4 is not intended to indicate that the elements of the method 400 are to be executed in any particular order, or that all of the elements of the method 400 are to be included in every case. Further, any number of additional elements not shown in FIG. 4 can be included within the method 400, depending on the details of the specific implementation.

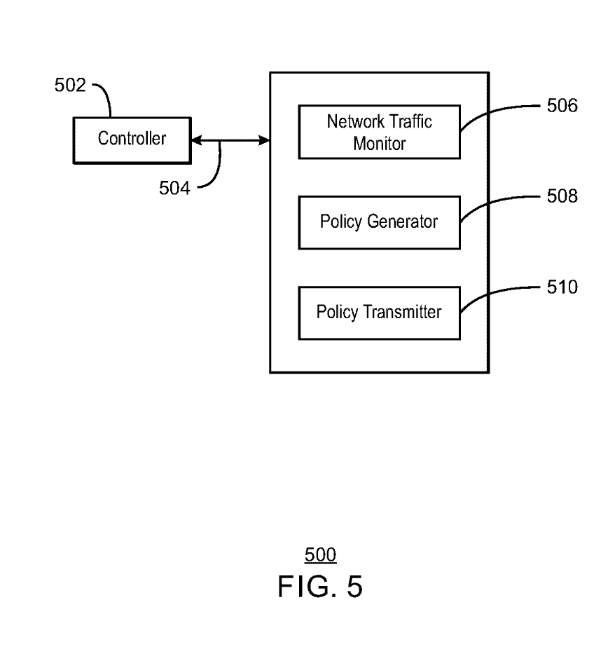

FIG. 5 is a block diagram of an example of a tangible, non-transitory, computer-readable medium that stores code configured to operate a node of a system with network security. The computer-readable medium is referred to by the reference number 500. The computer-readable medium 500 can include RAM, a hard disk drive, an array of hard disk drives, an optical drive, an array of optical drives, a non-volatile memory, a flash drive, a digital versatile disk (DVD), or a compact disk (CD), among others. The computer-readable medium 500 can be accessed by a controller 502 over a computer bus 504. For example, the computer-readable medium 500 can be accessed by a controller such as controller 110 illustrated in FIG. 1 and FIG. 2. Furthermore, the computer-readable medium 500 may include code configured to perform the methods described herein.

The various software components discussed herein may be stored on the computer-readable medium 500. In a computing system such as the one shown in FIG. 1, each of the components will be running on the controller 110. A region 506 can include a network traffic monitor to monitor and characterize network traffic through a network switch. A region 508 can include a policy generator to generate a policy to instruct a network switch in directing network traffic to a predetermined destination. A region 510 can include a policy transmitter to transmit the generated policy to the network switch for enforcement.

Although shown as contiguous blocks, the software components can be stored in any order or configuration. For example, if the tangible, non-transitory, computer-readable medium is a hard drive, the software components can be stored in non-contiguous, or even overlapping, sectors.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A computing system, comprising:
a network switch configured to direct network traffic;
a network device to receive the network traffic; and
a controller coupled to the network switch, the controller to:
monitor network traffic in the network switch; and
generate a policy to instruct the network switch in selecting a portion of the network traffic to direct to the network device.

2. The computing system of claim 1, wherein the network device comprises a network security device to perform packet inspection, and wherein the network switch is to direct the portion of the network traffic to the network security device as instructed by the controller.

3. The computing system of claim 2, wherein the policy is to comprise instructions directing the network switch to direct network traffic from a new network connection to the network security device for a calculated period of time.

4. The computing system of claim 2, wherein the policy is to comprise instructions directing the network switch to direct a calculated amount of network traffic from a new network connection to the network security device for scanning.

5. The computing system of claim 2, wherein the policy is to comprise instructions directing the network switch to direct a portion of network traffic selected at calculated time intervals to the network security device.

6. A method for directing network traffic, comprising:
receiving network traffic in a switch;
receiving, in the switch, instructions from a controller to direct a portion of the network traffic to a network device for processing; and
directing the portion of the network traffic to the network device as instructed by the controller.

7. The method of claim 6, wherein the network device comprises a network security device for packet inspection.

8. The method of claim 7, further comprising receiving notice of packet inspection results from the network security device in the controller and updating, in the controller, policy enforcement based on the packet inspection results.

9. The method of claim 6, further comprising monitoring, in the controller, network device capabilities and workload and directing the network traffic based on the network device capabilities and workload.

10. The method of claim 6, further comprising pre-filtering, in the switch, the portion of the network traffic to be sent to the network device.

11. A tangible, non-transitory, computer-readable medium comprising instructions that direct a controller to:
monitor network traffic in a network switch; and
generate a policy to instruct the network switch in directing the network traffic.

12. The tangible, non-transitory, computer-readable medium of claim 11, wherein the controller is to generate the policy to determine a destination of the network traffic and wherein the controller is to transmit the policy to the network switch to instruct the network switch to direct the network traffic to the determined destination.

13. The tangible, non-transitory, computer-readable medium of claim 11, further comprising code to direct the controller to:
instruct the network switch to direct network traffic to a network security device to perform packet inspection of network traffic.

14. The tangible, non-transitory, computer-readable medium of claim 13, wherein a predetermined portion of the network traffic is to be directed to the network security device and wherein the portion of network traffic is to be identified based on the policy generated by the controller.

15. The tangible, non-transitory, computer-readable medium of claim 14, wherein the policy is to comprise one of scanning network traffic from a new network connection for a calculated period of time, scanning a calculated amount of network traffic from a new network connection, scanning a portion of network traffic selected at calculated intervals, randomly selecting a portion of network traffic to scan, or a combination thereof.
